(19) United States
(12) Patent Application Publication
(10) Pub. No.: US 2014/0353506 A1
(43) Pub. Date: Dec. 4, 2014

(54) ELECTROMAGNETIC WAVE SPECTRUM ANALYZER AND INFRARED THERMAL IMAGE ANALYZER INCLUDING MULTIPLE RESONANCE STRUCTURES EACH HAVING DIFFERENT RESONANCE FREQUENCY

(71) Applicant: Samsung Electronics Co., Ltd., Suwon-Si (KR)

(72) Inventors: Sung-hyun NAM, Yongin-si (KR); Hae-seok PARK, Yongin-si (KR)

(73) Assignee: SAMSUNG ELECTRONICS CO., LTD., Suwon-Si (KR)

(21) Appl. No.: 13/892,616

(22) Filed: May 13, 2013

(30) Foreign Application Priority Data
Oct. 9, 2012 (KR) 10-2012-0112091

(51) Int. Cl. G01J 5/20

(52) U.S. Cl. CPC G01J 5/20; G01J 2005/202
USPC 250/349

(57) ABSTRACT

An electromagnetic wave spectrum analyzer includes a plurality of resonance structures each having a different resonance frequency, a plurality of thermal legs configured to support the plurality of resonance structures, a substrate including circuit elements configured to detect resistance changes in the plurality of thermal legs, and a signal processing unit configured to analyze a spectrum of incident electromagnetic waves from the resistance changes. The plurality of thermal legs are formed of a thermistor material of which an electrical resistance is changed due to thermal energy of electromagnetic waves absorbed by the plurality of resonance structures.

### CROSS-REFERENCE TO RELATED APPLICATION

This application claims the benefit of Korean Patent Application No. 10-2012-0112091, filed on Oct. 9, 2012, in the Korean Intellectual Property Office, the disclosure of which is incorporated herein in its entirety by reference.

### BACKGROUND

1. Field

Some example embodiments relate to an electromagnetic wave spectrum analyzer and an infrared thermal image analyzer including a plurality of resonance structures each having a different resonance frequency.

A. 2. Description of the Related Art

An absorber, which absorbs light having wavelengths of an infrared (or terahertz wave) band and converts the absorbed light into heat, is an essential component for bolometer-type detectors for reading generated heat from an electrical resistance change.

An absorber using the existing bolometers is a Salisbury screen type and has a layered structure in which a metal ground plate and a thin film absorber has a space of about λ/4 therebetween. Since the layered structure absorbs incident electromagnetic waves in a wide wavelength band, wavelength selectivity thereof is low, and accordingly, the layered structure is not suitable to analyze the incident electromagnetic waves.

A representative device for analyzing wavelengths in a wide infrared band is a Fourier Transform Infrared Spectrometer (FTIR). However, it is difficult for an FTIR spectrum analyzer to be integrated in a device because of the mechanically-scanning operational principle thereof.

The miniaturization of pixels is necessary to obtain a high-resolution infrared image. However, in general, when a pixel size is reduced, an incident energy amount is reduced due to the reduction of a pixel area, and a temperature variation is also reduced, thereby resulting in an increase in a temperature noise figure, and accordingly, the miniaturization of pixels is limited. To obtain a multi-wavelength infrared image by analyzing a spectrum of an incident wave even when a size of a device is small, a pixel array structure using an absorber, which absorbs a spectrum having a narrow linewidth and has a small cross section, is necessary.

### SUMMARY

Some example embodiments provide an electromagnetic wave spectrum analyzer and an infrared thermal image analyzer including a plurality of resonance structures each having a different resonance frequency.

Additional aspects will be set forth in part in the description which follows and, in part, will be apparent from the description, or may be learned by practice of example embodiments.

According to an example embodiment, an electromagnetic wave spectrum analyzer includes a plurality of resonance structures each having a different resonance frequency, a plurality of thermal legs configured to support the plurality of resonance structures, a substrate including circuit elements configured to detect resistance changes in the plurality of thermal legs, and a signal processing unit configured to analyze a spectrum of incident electromagnetic waves from the resistance changes. The plurality of thermal legs may be formed of a thermistor material of which an electrical resistance is changed due to thermal energy of electromagnetic waves absorbed by the plurality of resonance structures.

The electromagnetic waves may be one of infrared rays and terahertz waves. The resonance frequency of each of the plurality of resonance structures may be in one of an infrared and terahertz wave band.

A plurality of supporters may be on the substrate, and the plurality of supporters may be configured to support the plurality of thermal legs and electrically connect the plurality of thermal legs to the circuit elements included in the substrate. Each of the plurality of supporters may include a first spacer configured to connect a first end of a corresponding thermal leg of the plurality of thermal legs to the substrate, and a second spacer configured to connect a second end of the corresponding thermal leg of the plurality of thermal legs to the substrate, the second spacer separate from the first spacer.

A space may be between the plurality of thermal legs and the substrate. The space may include a low heat conductive layer. The low heat conductive layer may be a vacuum layer. A reflective metal layer may be in the space on the substrate. Each of the plurality of thermal legs may include at least one of non-crystalline silicon, a vanadium oxide, a nickel oxide, and silicon-germanium (Si—Ge).

The plurality of resonance structures may be a plurality of plasmon resonance structures. Each of the plurality of plasmon resonance structures may include an insulation material layer and a metal layer on the insulation material layer, and one of a shape and an area of a cross-section of the metal layer included in each of the plurality of plasmon resonance structures may be different from each other. The metal layer may include one of gold, silver, platinum, copper, aluminum, titanium, and an alloy of them.

A shape of a cross-section of the insulation material layer may be equal to the shape of the cross-section of the corresponding metal layer, and an area of a cross-section of the insulation material layer may be equal to or greater than the area of the cross-section of the corresponding metal layer. The shape of the cross-section of the metal layer may be a quadrangle.

The shape of the cross-section of the metal layer included in each of the plurality of plasmon resonance structures may be a quadrangle having a same length in a first direction and a different length in a second direction. The shape of the cross-section of the metal layer included in each of the plurality of plasmon resonance structures may be a one of a circle, an oval, a cross, a rod, a bent rod, and a mixed shape of horizontal rods and vertical rods.

According to another example embodiment, an infrared thermal image analyzer includes an array of a plurality of pixels, a substrate including circuit elements configured to detect resistance changes in the thermistor included in each of the plurality of pixels, and a signal processing unit configured to analyze a thermal image from the resistance changes. Each of the plurality of pixels includes an infrared absorber including a plurality of resonance structures each having a different resonance frequency, and a thermistor including a plurality of thermal legs supporting the plurality of resonance structures, the thermistor formed of a thermistor material of which an electrical resistance is changed by thermal energy from the infrared absorber.

A plurality of supporters may be on the substrate, and the plurality of supporters may be configured to support the plurality of thermal legs and electrically connect the plurality of thermal legs to the circuit elements included in the substrate.

Each of the plurality of supporters may include a first spacer configured to connect a first end of a corresponding thermal leg of the plurality of thermal legs to the substrate, and a second spacer configured to connect a second end of the corresponding thermal leg of the plurality of thermal legs to the substrate, the second spacer separate from the first spacer.

A space may be between the plurality of thermal legs and the substrate. The space may include a low heat conductive layer. The low heat conductive layer may be a vacuum layer. A reflective metal layer may be in the space on the substrate. The plurality of resonance structures may be a plurality of plasmon resonance structures. Each of the plurality of plasmon resonance structures may include an insulation material layer and a metal layer on the insulation material layer, and one of a shape and an area of a cross-section of the metal layer included in each of the plurality of plasmon resonance structures may be different from each other.

A shape of a cross-section of the insulation material layer may be equal to the shape of the cross-section of the corresponding metal layer, and an area of a cross-section of the insulation material layer may be equal to or greater than the area of the cross-section of the corresponding metal layer. The shape of the cross-section of the metal layer included in each of the plurality of plasmon resonance structures may be a quadrangle having a same length in a first direction and a different length in a second direction.

The shape of the cross-section of the metal layer included in each of the plurality of plasmon resonance structures may be a one of a circle, an oval, a cross, a rod, a bent rod, and a mixed shape of horizontal rods and vertical rods.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view of an electromagnetic wave spectrum analyzer according to an example embodiment;

FIG. 2A is a cross-sectional view through A-A′ of FIG. 1, and FIG. 2B is a top view of the electromagnetic wave spectrum analyzer of FIG. 1;

FIG. 3 is a graph of an illustrative light-absorbing spectrum with respect to a plurality of resonance structures included in the electromagnetic wave spectrum analyzer of FIG. 1;

FIGS. 4A to 4E illustrate various shapes of a plasmon resonance structure, which can be employed in the electromagnetic wave spectrum analyzer of FIG. 1; and

FIG. 5 is a partial top view of an infrared thermal image analyzer according to an example embodiment.

### DETAILED DESCRIPTION

An infrared detector will now be described in detail with reference to the accompanying drawings, wherein like reference numerals refer to the like elements throughout the drawings. In the drawings, sizes of components may be exaggerated for clarity and convenience of description. In this regard, the present embodiments may have different forms and should not be construed as being limited to the descriptions set forth herein. Accordingly, the embodiments are merely described below, by referring to the figures, to explain aspects of the present description.

It will be understood that, although the terms “first”, “second”, etc. may be used herein to describe various elements, components, regions, layers and/or sections, these elements, components, regions, layers and/or sections are not to be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments are not to be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, is to be interpreted as having a meaning that is consistent with their meaning in the context of the relevant art and will not be interpreted in an idealized or overly formal sense unless expressly so defined herein.

An electromagnetic wave spectrum analyzer and an infrared thermal image analyzer according to embodiments analyze a spectrum and a thermal image of incident electromagnetic waves by using a plurality of resonance structures each having a different resonance frequency as a heat absorber. A size of the heat absorber may be small in correspondence with high pixelization to perform such an analysis at high resolution, and to do this, a surface plasmon resonance structure or a metamaterial resonance structure is used as the heat absorber. Such a resonance structure shows a resonance phenomenon at a given (or alternatively, predetermined) frequency, for example, causes surface plasmon resonance due to a strong and specific interaction with an electromagnetic wave at an interface between a high-conductive metal film and a dielectric, and has a relatively high absorbance for incident light of a band of the given (or alternatively, predetermined) frequency.

Almost 100% of light may be absorbed at such a resonance frequency, and a linewidth of an absorption spectrum is much narrower than a case of an existing Salisbury screen. In addition, since an optical absorption cross-sectional area is much greater than a geometric absorption cross-sectional area, a resonance structure having a much smaller size than a pixel size may be used. Using these characteristics, a sensor for analyzing a spectrum of an incident wavelength and obtaining a multi-wavelength image may be constructed with a small device size.

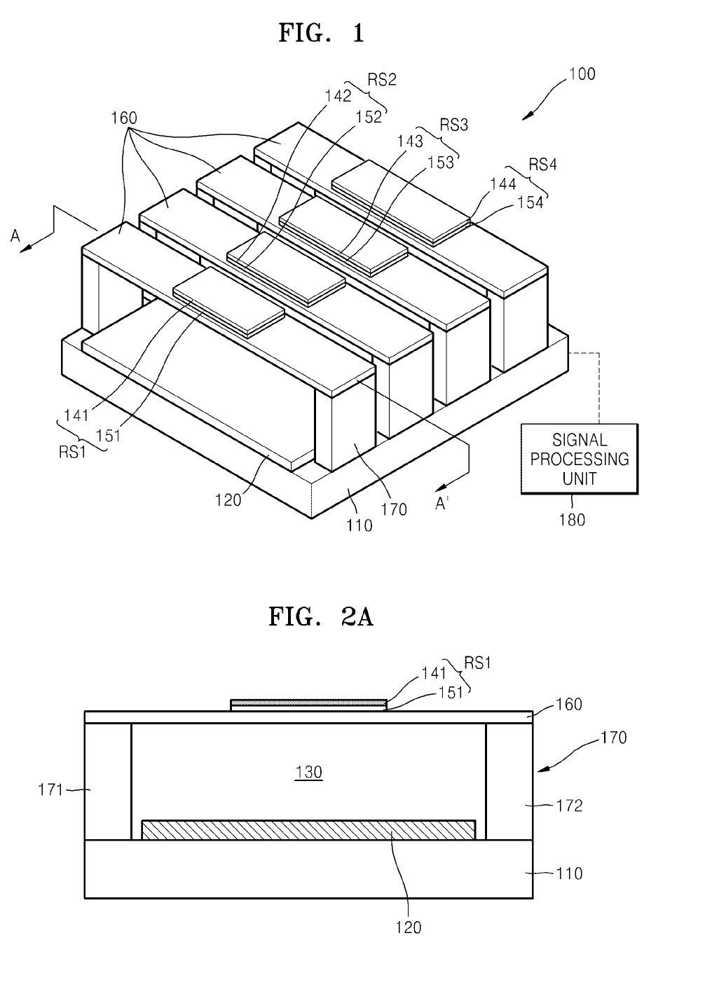

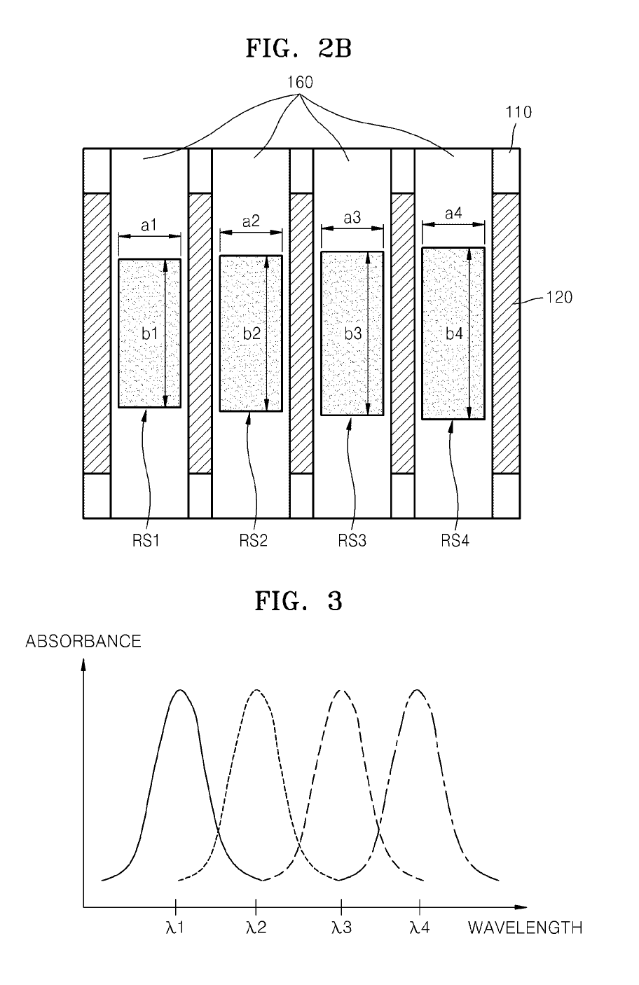

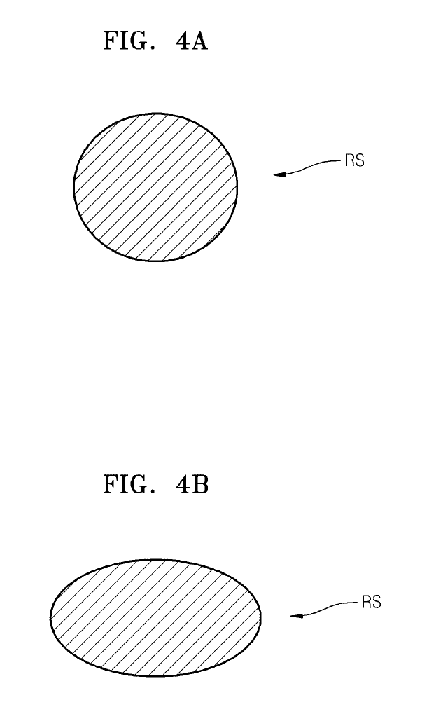

FIG. 1 is a perspective view of an electromagnetic wave spectrum analyzer 100 according to an example embodiment, FIG. 2A is a cross-sectional view through A-A′ of FIG. 1, and FIG. 2B is a top view of the electromagnetic wave spectrum analyzer 100 of FIG. 1. FIG. 3 is a graph of an illustrative light-absorbing spectrum with respect to a plurality of resonance structures RS1, RS2, RS3, and RS4 included in the electromagnetic wave spectrum analyzer 100 of FIG. 1.

The electromagnetic wave spectrum analyzer 100 includes the plurality of resonance structures RS1, RS2, RS3, and RS4, a plurality of thermal legs 160, which respectively support the plurality of resonance structures RS1, RS2, RS3, and RS4 and are formed of a thermistor material of which an electrical resistance is changed due to thermal energy of electromagnetic waves absorbed by the plurality of resonance structures RS1, RS2, RS3, and RS4, a substrate 110 having circuit elements (not shown) for detecting resistance changes in the plurality of thermal legs 160, and a signal processing unit 180 for analyzing a spectrum of incident electromagnetic waves from the resistance changes.

In addition, a plurality of supporters 170, which support the plurality of thermal legs 160 and electrically connect the plurality of thermal legs 160 to the circuit elements included in the substrate 110, may be formed on the substrate 110. Each of the plurality of supporters 170 may include a first spacer 171 for connecting a first end of a corresponding thermal leg 160 to the substrate 110 and a second spacer 172, which is separated from the first spacer 171, and connects a second end of the corresponding thermal leg 160 to the substrate 110.

The plurality of resonance structures RS1, RS2, RS3, and RS4 have a structure causing a resonance phenomenon at given (or alternatively, predetermined) wavelengths of a wavelength band of incident electromagnetic waves as an absorber for absorbing thermal energy from the incident electromagnetic waves. In addition, the plurality of resonance structures RS1, RS2, RS3, and RS4 may be formed as plasmon resonance structures so as to increase an absorbance and decrease a width of a light-absorbing spectrum.

The plurality of resonance structures RS1, RS2, RS3, and RS4 include insulation material layers 151, 152, 153, and 154 and metal layers 141, 142, 143, and 144 disposed on the insulation material layers 151, 152, 153, and 154, respectively. The plurality of resonance structures RS1, RS2, RS3, and RS4 are formed to have different resonance frequencies, and for this, cross-sectional shapes or areas of the metal layers 141, 142, 143, and 144 are formed to be different from each other. Although four resonance structures RS1, RS2, RS3, and RS4 are shown in FIG. 1, this is only an illustration, and another number of resonance structures may be used instead.

The metal layers 141, 142, 143, and 144 are formed of a high-conductive metal material to cause plasmon resonance and may include, for example, gold, silver, platinum, copper, aluminum, titanium, or an alloy of them.

The cross-sectional shapes of the metal layers 141, 142, 143, and 144 may be quadrangles. For example, as shown in FIG. 2B, the cross-sectional shapes of the metal layers 141, 142, 143, and 144 included in the plurality of resonance structures RS1, RS2, RS3, and RS4 may have first lengths (for example, horizontal lengths) of a1, a2, a3, and a4 and second lengths (for example, vertical lengths) of b1, b2, b3, and b4, respectively. In addition, the cross-sectional shapes of the metal layers 141, 142, 143, and 144 may be formed to have the same horizontal length and different vertical lengths. According to this structure, electromagnetic waves of polarization component among incident electromagnetic waves resonate at different wavelength bands according to the vertical lengths b1, b2, b3, and b4 of the plurality of resonance structures RS1, RS2, RS3, and RS4. For example, as shown in FIG. 3, the plurality of resonance structures RS1, RS2, RS3, and RS4 have peak absorbance values at wavelengths of λ1, λ2, λ3, and λ4, respectively.

Cross-sectional shapes of the insulation material layers 151, 152, 153, and 154 may be equal to the cross-sectional shapes of the metal layers 141, 142, 143, and 144, respectively, and cross-sectional areas of the insulation material layers 151, 152, 153, and 154 may be equal to or greater than the cross-sectional shapes of the metal layers 141, 142, 143, and 144, respectively.

Energy of electromagnetic waves absorbed by the plurality of resonance structures RS1, RS2, RS3, and RS4 is converted into thermal energy and transferred to the plurality of thermal legs 160, respectively.

The plurality of thermal legs 160 support the plurality of resonance structures RS1, RS2, RS3, and RS4, respectively, and act as a path through which a current flows so as to detect a change in an electrical resistance due to heat. The plurality of thermal legs 160 are formed of a thermistor material of which an electrical resistance is changed due to heat. The plurality of thermal legs 160 may include a material having a high temperature coefficient of resistance (TCR), for example, at least one selected from the group consisting of non-crystalline silicon, a vanadium oxide, a nickel oxide, and silicon-germanium (Si—Ge). Heat generated by the plurality of resonance structures RS1, RS2, RS3, and RS4 may be transferred to only the plurality of thermal legs 160, and for this, a space 130 between the plurality of thermal legs 160 and the substrate 110 may be formed as a low heat conductive layer, for example, a vacuum layer.

In addition, a reflective metal layer 120 may be formed in the space 130 on the substrate 110. The reflective metal layer 120 is provided for incident light not to travel towards the substrate 110 and may be formed with a thickness of about 100 nm or more. Thus, the substrate 110 below the reflective metal layer 120 hardly affects the resonance phenomenon.

A plurality of first spacers 171 and a plurality of second spacers 172 forming the plurality of supporters 170 allow an electrical junction between the substrate 110 and the plurality of thermal legs 160. The substrate 110 includes circuit elements for detecting resistance changes in the plurality of thermal legs 160, and the plurality of first spacers 171 and the plurality of second spacers 172 electrically connect the plurality of thermal legs 160 and the circuit elements. For this, the plurality of first spacers 171 and the plurality of second spacers 172 may include a conductive material, for example, may have a structure in which metal wirings for connecting the circuit elements of the substrate 110 to the plurality of thermal legs 160 are formed therein in a shape of a core surrounded by an insulation material. A current flows through the plurality of thermal legs 160 via the plurality of supporters 170, and resistance changes in the plurality of thermal legs 160 due to heat absorbed by the plurality of thermal legs 160 are detected.

The signal processing unit 180 analyzes a spectrum of incident electromagnetic waves from the detected resistance changes. That is, the signal processing unit 180 may detect spectral components of the incident electromagnetic waves by analyzing magnitudes of thermal energy absorbed by the plurality of resonance structures RS1, RS2, RS3, and RS4. In this case, as the number of resonance structures RS1, RS2, RS3, and RS4 is larger, a space between the resonance frequencies of the plurality of resonance structures RS1, RS2, RS3, and RS4 is narrower, and absorption spectrum linewidths of the plurality of resonance structures RS1, RS2, RS3, and RS4 are narrower such that a spectrum may be analyzed at higher resolution. Geometric shapes of the metal layers 141, 142, 143, and 144 may be adjusted so that the resonance frequencies of the plurality of resonance structures RS1, RS2, RS3, and RS4 are formed with a given (or alternatively, predetermined) space therebetween at a wavelength band of interest. For example, the incident electromagnetic waves may be infrared rays or terahertz waves, and in this case, the plurality of resonance structures RS1, RS2, RS3, and RS4 may be formed to have different resonance frequencies at an infrared or terahertz wave band.

The signal processing unit 180 may be included in the substrate 110 in a form of an integrated circuit (IC) together with circuit elements for detecting a resistance change. Each of the cross-sectional shapes of the metal layers may be a circle, an oval, a cross, a rod, a bent rod, or a mixed shape of horizontal rods and vertical rods.

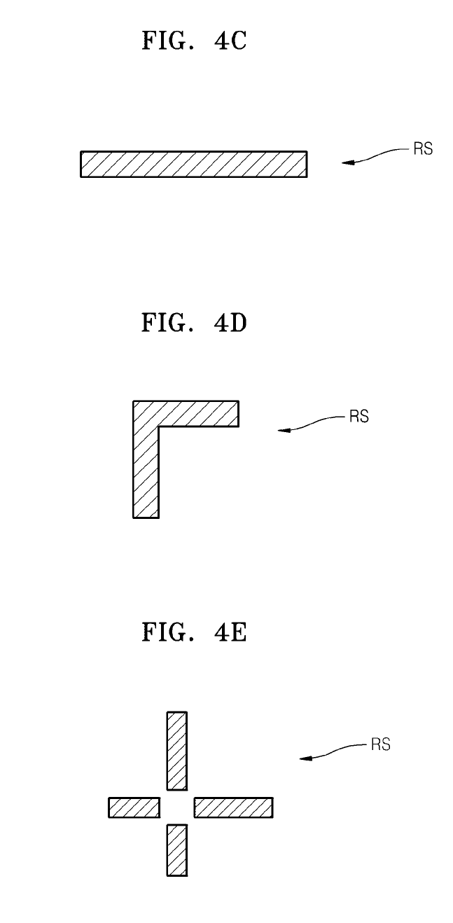

FIGS. 4A to 4E illustrate various shapes of a plasmon resonance structure RS, which can be employed in the electromagnetic wave spectrum analyzer 100 of FIG. 1.

As shown in FIGS. 4A and 4B, a cross-sectional shape of a metal layer in the plasmon resonance structure RS may be formed as a circle (FIG. 4A) or an oval (FIG. 4B).

Alternatively, a rod shape as shown in FIG. 4C may be employed as the cross-sectional shape of the metal layer in the plasmon resonance structure RS to adjust a resonance frequency for a polarization component in a horizontal direction.

Alternatively, the cross-sectional shape of the metal layer in the plasmon resonance structure RS may be formed as a bent rod shape as shown in FIG. 4D or a mixed shape of horizontal rods and vertical rods as shown in FIG. 4E. These shapes may have a structure for adjusting both a resonance frequency for a polarization component in a horizontal direction and a resonance frequency for a polarization component in a vertical direction.

Besides, various geometric shapes that are relatively easy to form a plurality of resonance structures having different resonance frequencies at a wavelength band of interest may be employed.

Although the electromagnetic wave spectrum analyzer 100 described above employs a plasmon resonance structure as a resonance structure, a resonance structure using a metamaterial may be used instead.

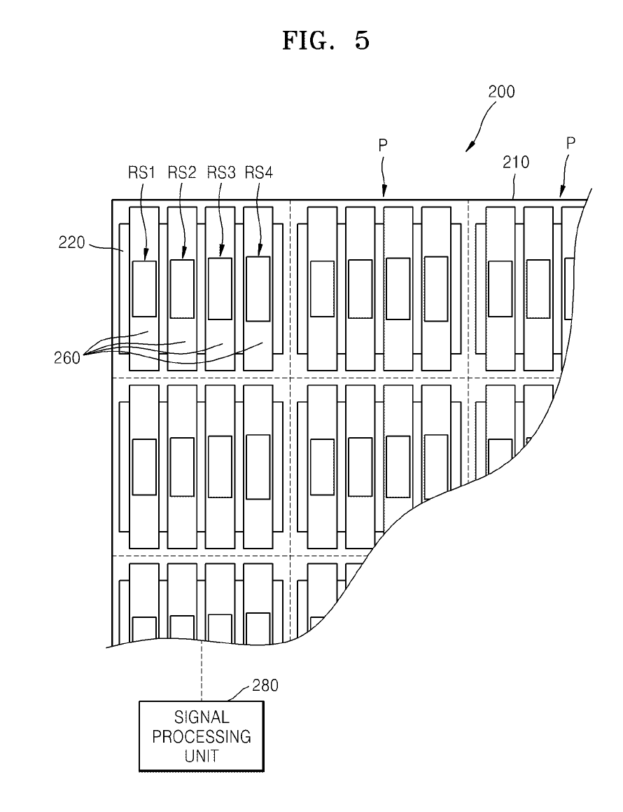

FIG. 5 is a partial top view of an infrared thermal image analyzer 200 according to an example embodiment. The infrared thermal image analyzer 200 uses the principle that an object having an arbitrary temperature T emits light of a wide band indicating a maximum value at a given (or alternatively, predetermined) wavelength due to black body radiation. An object having a given (or alternatively, predetermined) temperature distribution emits electromagnetic waves having a spectrum at a given (or alternatively, predetermined) wavelength band, and sensors capable of analyzing a spectrum of incident electromagnetic waves may be arrayed to obtain a thermal image from spectral information analyzed by the sensors.

The infrared thermal image analyzer 200 includes an array of a plurality of pixels P each including an infrared absorber and a thermistor formed of a material of which an electrical resistance is changed by thermal energy from the infrared absorber, a substrate 210 having circuit elements for detecting resistance changes in thermistors included in the plurality of pixels P, and a signal processing unit 280 for analyzing a thermal image from the resistance changes.

The infrared absorber incudes a plurality of resonance structures RS1, RS2, RS3, and RS4 each having a different resonance frequency, and the thermistor is formed of a thermistor material and includes a plurality of thermal legs 160 for respectively supporting the plurality of resonance structures RS1, RS2, RS3, and RS4.

The plurality of resonance structures RS1, RS2, RS3, and RS4 may employ plasmon resonance structures having substantially the same structure as shown in FIG. 1 and may also have the shapes as shown in FIGS. 4A to 4E or other various geometric shapes.

The substrate 210 includes circuit elements for detecting resistance changes in the plurality of thermal legs 260, and the circuit elements and the plurality of thermal legs 260 are electrically connected to each other by a plurality of supporters (not shown) having substantially the same structure as shown in FIG. 1.

The signal processing unit 280 analyzes a spectrum of incident electromagnetic waves and temperatures corresponding thereto from resistance changes in the plurality of thermal legs 260 and analyzes a thermal image from information of each pixel P. The signal processing unit 280 may be arranged in the substrate 210 in a form of an IC together with the circuit elements for detecting resistance changes.

In addition, a reflective metal layer 220 may be formed on the substrate 210. The reflective metal layer 220 is provided for incident light not to travel towards the substrate 210 and may be formed with a thickness of about 100 nm or more.

As described above, according to example embodiments, an electromagnetic wave spectrum analyzer and an infrared thermal image analyzer may respectively analyze a spectrum and a thermal image at high resolution by packaging a plurality of resonance structures having different resonance frequencies into a single pixel. The number and concrete shapes of resonance structures and concrete shapes of thermal legs may be variously modified besides the illustrated structure. For example, geometric shapes of the resonance structures may be adjusted to form different resonance frequencies at a wavelength band of interest. The shapes of the thermal legs may also be variously modified so that heat absorbed by the resonance structures efficiently causes a change in an electrical resistance.

The electromagnetic wave spectrum analyzer may analyze a multi-wavelength spectrum by using a plurality of resonance structures having different resonance frequencies as an absorber and using a plasmon resonance structure or a metamaterial resonance structure having a high absorbance and a narrow absorption spectrum linewidth.

The infrared thermal image analyzer may obtain a thermal image from a spectrum of each pixel by arraying a plurality of pixels using a plurality of resonance structures having different resonance frequencies as an absorber.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. An electromagnetic wave spectrum analyzer comprising:
a plurality of resonance structures each having a different resonance frequency;
a plurality of thermal legs configured to support the plurality of resonance structures, the plurality of thermal legs formed of a thermistor material of which an electrical resistance is changed due to thermal energy of electromagnetic waves absorbed by the plurality of resonance structures;
a substrate including circuit elements configured to detect resistance changes in the plurality of thermal legs; and
a signal processing unit configured to analyze a spectrum of incident electromagnetic waves from the resistance changes.

2. The electromagnetic wave spectrum analyzer of claim 1, wherein the electromagnetic waves are one of infrared rays and terahertz waves.

3. The electromagnetic wave spectrum analyzer of claim 1, wherein the resonance frequency of each of the plurality of resonance structures are in one of an infrared and terahertz wave band.

4. The electromagnetic wave spectrum analyzer of claim 1, further comprising:
a plurality of supporters on the substrate, the plurality of supporters configured to support the plurality of thermal legs and electrically connect the plurality of thermal legs to the circuit elements included in the substrate.

5. The electromagnetic wave spectrum analyzer of claim 4, wherein each of the plurality of supporters comprises:
a first spacer configured to connect a first end of a corresponding thermal leg of the plurality of thermal legs to the substrate; and
a second spacer configured to connect a second end of the corresponding thermal leg of the plurality of thermal legs to the substrate, the second spacer separate from the first spacer.

6. The electromagnetic wave spectrum analyzer of claim 5, wherein a space is between the plurality of thermal legs and the substrate.

7. The electromagnetic wave spectrum analyzer of claim 6, wherein the space includes a low heat conductive layer.

8. The electromagnetic wave spectrum analyzer of claim 7, wherein the low heat conductive layer is a vacuum layer.

9. The electromagnetic wave spectrum analyzer of claim 6, further comprising:
a reflective metal layer in the space on the substrate.

10. The electromagnetic wave spectrum analyzer of claim 1, wherein each of the plurality of thermal legs includes at least one of non-crystalline silicon, a vanadium oxide, a nickel oxide, and silicon-germanium (Si-Ge).

11. The electromagnetic wave spectrum analyzer of claim 1, wherein the plurality of resonance structures are a plurality of plasmon resonance structures.

12. The electromagnetic wave spectrum analyzer of claim 11, wherein each of the plurality of plasmon resonance structures includes an insulation material layer and a metal layer on the insulation material layer, and one of a shape and an area of a cross-section of the metal layer included in each of the plurality of plasmon resonance structures are different from each other.

13. The electromagnetic wave spectrum analyzer of claim 12, wherein the metal layer includes one of gold, silver, platinum, copper, aluminum, titanium, and an alloy of them.

14. The electromagnetic wave spectrum analyzer of claim 12, wherein a shape of a cross-section of the insulation material layer is equal to the shape of the cross-section of the corresponding metal layer, and an area of a cross-section of the insulation material layer is equal to or greater than the area of the cross-section of the corresponding metal layer.

15. The electromagnetic wave spectrum analyzer of claim 12, wherein the shape of the cross-section of the metal layer is a quadrangle.

16. The electromagnetic wave spectrum analyzer of claim 12, wherein the shape of the cross-section of the metal layer included in each of the plurality of plasmon resonance structures is a quadrangle having a same length in a first direction and a different length in a second direction.

17. The electromagnetic wave spectrum analyzer of claim 12, wherein the shape of the cross-section of the metal layer included in each of the plurality of plasmon resonance structures is a one of a circle, an oval, a cross, a rod, a bent rod, and a mixed shape of horizontal rods and vertical rods.

18. An infrared thermal image analyzer comprising:
an array of a plurality of pixels,
each of the plurality of pixels including,
an infrared absorber including a plurality of resonance structures
each having a different resonance frequency, and
a thermistor including a plurality of thermal legs supporting the plurality of resonance structures, the thermistor formed of a thermistor material of which an electrical resistance is changed by thermal energy from the infrared absorber;
a substrate including circuit elements configured to detect resistance changes in the thermistor included in each of the plurality of pixels; and
a signal processing unit configured to analyze a thermal image from the resistance changes.

19. The infrared thermal image analyzer of claim 18, further comprising:
a plurality of supporters on the substrate, the plurality of supporters configured to support the plurality of thermal legs and electrically connect the plurality of thermal legs to the circuit elements included in the substrate.

20. The infrared thermal image analyzer of claim 19, wherein each of the plurality of supporters comprises:
a first spacer configured to connect a first end of a corresponding thermal leg of the plurality of thermal legs to the substrate; and
a second spacer configured to connect a second end of the corresponding thermal leg of the plurality of thermal legs to the substrate, the second spacer separate from the first spacer.

21. The infrared thermal image analyzer of claim 20, wherein a space is between the plurality of thermal legs and the substrate.

22. The infrared thermal image analyzer of claim 21, wherein the space includes a low heat conductive layer.

23. The infrared thermal image analyzer of claim 22, wherein the low heat conductive layer is a vacuum layer.

24. The infrared thermal image analyzer of claim 21, further comprising:
a reflective metal layer in the space on the substrate.

25. The infrared thermal image analyzer of claim 18, wherein the plurality of resonance structures are a plurality of plasmon resonance structures.

26. The infrared thermal image analyzer of claim 25, wherein each of the plurality of plasmon resonance structures includes an insulation material layer and a metal layer on the insulation material layer, and
one of a shape and an area of a cross-section of the metal layer included in each of the plurality of plasmon resonance structures are different from each other.

27. The infrared thermal image analyzer of claim 26, wherein a shape of a cross-section of the insulation material layer is equal to the shape of the cross-section of the corresponding metal layer, and an area of a cross-section of the insulation material layer is equal to or greater than the area of the cross-section of the corresponding metal layer.

28. The infrared thermal image analyzer of claim 26, wherein the shape of the cross-section of the metal layer included in each of the plurality of plasmon resonance structures is a quadrangle having a same length in a first direction and a different length in a second direction.

29. The infrared thermal image analyzer of claim 26, wherein the shape of the cross-section of the metal layer included in each of the plurality of plasmon resonance structures is a one of a circle, an oval, a cross, a rod, a bent rod, and a mixed shape of horizontal rods and vertical rods.
